(19) United States
(12) Patent Application Publication
(10) Pub. No.: US 2026/0291989 A1
(43) Pub. Date: Sep. 24, 2026

(54) METHOD AND SYSTEM FOR TRIGGERING REMEDIAL ACTION ON CLIENT DEVICE

(71) Applicant: Y.E. Hub Armenia LLC, Yerevan (AM)

(72) Inventors: Vasily ZIUZIN, Moscow (RU); Vitaly KALCHENKO, Novosibirsk (RU); Zinovy NIS, Moscow (RU); Alexander ULYANOV, Moscow (RU)

(21) Appl. No.: 19/461,149

(22) Filed: Jan. 27, 2026

(30) Foreign Application Priority Data
Mar. 18, 2025 (RU) 2025106327

(51) Int. Cl. H04L 9/40

(52) U.S. Cl. CPC H04L 63/1483

(57) ABSTRACT

Methods, servers, client devices, systems and processors for triggering a remedial action on a client device are disclosed. The method includes, during a client-side phase: acquiring, using a browser, generating, using a client-side DSSM executed on the client device, a DSSM output based on the client-side webpage data, generating, using a client-side GB model, a client-side probability score based on the DSSM output and the client-side webpage data, and in response to the client-side probability score being above a pre-determined threshold, selectively triggering a server-side phase. The method includes, during a server-side phase: acquiring the DSSM output, acquiring server-side webpage data indicative of the webpage being accessed by the client device, generating, using a server-side GB model, a server-side probability score based on the DSSM output and the server-side webpage data, and in response to the server-side probability score being above an other pre-determined threshold, selectively triggering the remedial action.

### CROSS-REFERENCE

The present application claims priority to Russian Patent Application No. 2025106327, entitled “Method and System for Triggering Remedial Action on Client Device”, filed Mar. 18, 2025, the entirety of which is incorporated herein by reference.

### FIELD

The present technology generally relates to cybersecurity, and in particular, to methods and systems for triggering a remedial action on a client device.

### BACKGROUND

The increasing reliance on web-based platforms has led to a rise in various online threats, including “phishing”, website cloning, and malware distribution (e.g., ransomware). For example, phishing websites often attempt to deceive users leading to unauthorized data access or leakage, financial fraud, and/or malware infections.

Several phishing detection solutions exist in the prior art, many of which rely on server-side analysis. These server-based systems maintain databases of known malicious websites and employ analytical models to detect new threats. However, as the number of websites, and new phishing techniques, on the internet continues to grow exponentially, these centralized solutions face challenges in scalability and real-time detection.

At least one limitation of traditional phishing detection methods is their inability to adapt quickly to new and/or evolving threats. Malicious actors frequently modify their techniques, making it difficult for pre-existing detection models to remain effective. Furthermore, retraining an entire detection system to account for new attack patterns can be computationally expensive and time-consuming.

US Patent number 10,104,113 discloses machine learning techniques for classification of benign and malicious webpages.

### SUMMARY

It is an object of the present technology to improve at least one drawback associated with the relevant prior art.

Developers have realized that some prior art solutions may be ill-suited for frequent updates and/or re-training methods in order to face new phishing techniques. Conventional solutions may employ one or more machine learning models that need to be fully re-trained when a new type of phishing technique is to be conditioned for and/or when current webpage content is modified. As a result, there is a need for a detection system that is capable to be updated and/or re-trained in a more time efficient manner and/or while consuming comparatively less computational resources.

In some embodiments of the present technology, there is provided a detection system that is configured to have a better classification performance than at least some conventional solutions. In at least some embodiments of the present technology, performance of the model has been evaluated using content of partner feeds and available phishing data. Phishing detection recall metric using an implementation of the present technology on this data has a been measured at above 72%, while the precision metric using the implementation of the present technology on this data has a been measured at above 99%. In this context, precision and recall are metrics used to evaluate the effectiveness of the phishing detection system. Precision (above 99%) can measure how many of the URLs that the model flagged as “phishing” are actually phishing. A high precision may be indicative of that when the system identifies a URL as phishing, it is substantially always correct, minimizing false positives (i.e., mistakenly classifying legitimate sites as phishing). Recall (about 72%) measures how many of the actual phishing URLs in the dataset the system successfully detected. A recall of about 72% means that the model identifies about 72% of all phishing URLs present in the data, but it may still miss some (i.e., false negatives).

In some embodiments of the present technology, there is provided a detection system that is configured to have a more efficient updating and/or re-training operations than at least some conventional solutions for conditioning the phishing detection system for a new phishing technique. In some implementations, the detection system may be updated and/or re-training to obtain a response rate to a new threat of a day and/or up to a week.

In the context of the present technology, the detection system operates in accordance with a two-stage process comprising (i) a client-side stage using client-side models and data, and (ii) a server-side stage using server-side models and data, to improve detection accuracy and/or efficiency.

The first stage is executed by a client device using a browser application. In some embodiments, the first stage may be executed by the client device in real-time and/or before a webpage is loaded and displayed to a user of the client device.

The client device is configured to execute a browser application, a first client-side machine learning model and a second client-side machine learning model. The first client-side machine learning model may be a Deep Structured Semantic Model (DSSM). The second client-side machine learning model may be a Gradient Boosting Model (GBM).

The client device is configured to employ the first and second client-side machine learning models to generate one or more predictions based on client-side data. The client-side data may comprise webpage data that is accessible to the browser application executed on the client device. The one or more predictions may be indicative of a client-side probability score indicative of the likelihood of the webpage being malicious.

In some embodiments, client-side data may comprise a screenshot of the webpage generated by the browser application and provided to a third client-side machine learning model configured to extract visual features from the screenshot and use them as an additional input for generating the client-side probability score. The third client-side machine learning model may be a Convolutional Neural Network (CNN) executed on the client device.

In response to the client-side probability score being above a client-side pre-defined threshold, the browser application is configured to transmit data to a server for the second stage of the process. In some embodiments, the client device may be configured to transmit client-side data and/or an indication to trigger the second stage of the process. In other embodiments, the server may be configured to trigger the second stage of the process based on data received from the client device.

In some embodiments, the second stage may be executed by the server in real-time and/or before a webpage is loaded and displayed to a user of the client device.

The server is configured to execute a server-side machine learning model. The server-side machine learning model may be a GBM. In some embodiments, the client-side detection model(s) may use only html page features, text content, and visual page content. In some embodiments, the server-side detection model(s) may additionally use data about a given website (internal statistics, information about the owner/operator, information about traffic to the site, and the like).

The client device is configured to employ the first and second client-side machine learning models to generate one or more predictions based on client-side data and server-side data. The server-side data may comprise webpage data that is accessible to the server from a database system. It is contemplated that the database system may be configured store additional information, crawled and/or pre-computed, about a given webpage. The one or more predictions may be indicative of a server-side probability score indicative of the likelihood of the webpage being malicious.

In response to the server-side probability score being above a server-side pre-defined threshold, the server is configured to trigger an indication for the user via the browser application. In some embodiments, the client device may be configured to display a visual indicator for the user using the browser application. One or more other types of indicators may be triggered for the user via the browser application, without departing from the scope of the present technology.

Developers have realized that this two-stage, hybrid, approach may aid in reducing server load by filtering out a large number of benign webpages on the client-side, enhance detection speed and/or provide a more scalable, accurate, and/or computationally efficient phishing detection mechanism.

It is contemplated that that client-side stage and the server-side stage of the hybrid detection framework may be enabled by a single operating entity. For example, an operating entity of the server-side stage may be the same operating entity that provides a browser application executed on the client-side. As a result, the server-side stage may be configured on a server operated by a same entity as the one operating the browser application executed on the client device.

In a first broad aspect of the present technology, there is provided a method of triggering a remedial action on a client device, the client device being communicatively coupled to a server, the method comprising: acquiring, using a browser application executed on the client device, client-side webpage data indicative of a webpage being accessed by the client device; generating, using a client-side DSSM executed on the client device, a DSSM output based on the client-side webpage data, the DSSM output being indicative of (i) features representing the webpage and (ii) a preliminary likelihood of that the webpage is a malicious webpage; generating, using a client-side GB model executed on the client device, a client-side probability score based on the DSSM output and the client-side webpage data, the client-side probability score being indicative of a client-side likelihood of the webpage is a malicious webpage; and in response to the client-side probability score being above a pre-determined threshold, selectively triggering a server-side phase; and acquiring, by the server from the client device, the DSSM output; acquiring, by the server, server-side webpage data indicative of the webpage being accessed by the client device; generating, using a server-side GB model executed on the server, a server-side probability score based on the DSSM output and the server-side webpage data, the server-side probability score being indicative of a server-side likelihood of the webpage is a malicious webpage; and in response to the server-side probability score being above an other pre-determined threshold, selectively triggering the remedial action.

In some aspects, the techniques described herein relate to a method, wherein the method further includes generating one or more client-side counters based on the client-side webpage data.

In some aspects, the techniques described herein relate to a method, wherein the client-side webpage data includes a URL, a title, and other content of webpage.

In some aspects, the techniques described herein relate to a method, wherein the method further includes generating one or more server-side counters based on the server-side webpage data.

In some aspects, the techniques described herein relate to a method, wherein the method further includes the DSSM output includes one or more embeddings indicative of features representing the webpage, and a preliminary probability score.

In some aspects, the techniques described herein relate to a method, wherein the method further includes using a vision model to generate an other embedding indicative of visual features of a screenshot of the webpage generated by the browser application, and using the other embedding for generating the client-side probability score.

In some aspects, the techniques described herein relate to a method, wherein the selectively triggering the remedial action includes triggering display of a visual element to a user using the browser application and indicative of that the webpage is a malicious webpage.

In a second broad aspect of the present technology, there is provided a system for triggering a remedial action on a client device, the system comprising the client device communicatively coupled to a server, the system being configured to: during a client-side phase: acquire, using a browser application executed on the client device, client-side webpage data indicative of a webpage being accessed by the client device; generate, using a client-side DSSM executed on the client device, a DSSM output based on the client-side webpage data, the DSSM output being indicative of (i) features representing the webpage and (ii) a preliminary likelihood of that the webpage is a malicious webpage; generate, using a client-side GB model executed on the client device, a client-side probability score based on the DSSM output and the client-side webpage data, the client-side probability score being indicative of a client-side likelihood of the webpage is a malicious webpage; and in response to the client-side probability score being above a pre-determined threshold, selectively trigger a server-side phase; and during the server-side phase: acquire, by the server from the client device, the DSSM output; acquire, by the server, server-side webpage data indicative of the webpage being accessed by the client device; generate, using a server-side GB model executed on the server, a server-side probability score based on the DSSM output and the server-side webpage data, the server-side probability score being indicative of a server-side likelihood of the webpage is a malicious webpage; and in response to the server-side probability score being above an other pre-determined threshold, selectively trigger the remedial action.

In some aspects, the techniques described herein relate to a system, wherein the system is further configured to generate one or more client-side counters based on the client-side webpage data.

In some aspects, the techniques described herein relate to a system, wherein the client-side webpage data includes a URL, a title, and other content of webpage.

In some aspects, the techniques described herein relate to a system, wherein the system is further configured to generate one or more server-side counters based on the server-side webpage data.

In some aspects, the techniques described herein relate to a system, wherein the DSSM output includes one or more embeddings indicative of features representing the webpage, and a preliminary probability score.

In some aspects, the techniques described herein relate to a system, wherein the system is further configured to use a vision model to generate an other embedding indicative of visual features of a screenshot of the webpage generated by the browser application, and to use the other embedding for generating the client-side probability score.

In some aspects, the techniques described herein relate to a system, wherein to selectively trigger the remedial action includes the system configured to trigger display of a visual element to a user using the browser application and indicative of that the webpage is a malicious webpage.

In a third broad aspect of the present technology, there is provided a method of triggering a remedial action on a client device, the client device being communicatively coupled to a server, the method including: acquiring, by the server from the client device, an indication for triggering server-side classification of a webpage, the indication including a DSSM output, the indication being acquired in response to a client-side classification of the webpage, the client-side classification being performed by a DSSM model and a GB model executed on the client device, the DSSM model having been configured to generate the DSSM output based on browser webpage data, the DSSM output being indicative of (i) features representing the webpage and (ii) a preliminary likelihood of the webpage being a malicious webpage, and the GB model having been configured to generate, based on the DSSM output and the browser webpage data, a client-side probability score indicative of a client-side likelihood of the webpage being a malicious webpage, acquiring, by the server, server-side webpage data; and generating, using a server-side GB model executed on the server, a server-side probability score based on the DSSM output and the server-side webpage data, the server-side probability score being indicative of a server-side likelihood of the webpage being a malicious webpage; and in response to the server-side probability score being above a pre-determined threshold, selectively triggering the remedial action.

### DESCRIPTION OF THE DRAWINGS

For a better understanding of the present technology, as well as other aspects and further features thereof, reference is made to the following description which is to be used in conjunction with the accompanying drawings, where:

FIG. 1 is a schematic diagram depicting a system, the system being implemented in accordance with non-limiting embodiments of the present technology;

FIG. 2 is a schematic illustration of a two-stage detection mechanism executed by the system of FIG. 1, in accordance with non-limiting embodiments of the present technology;

FIG. 3 is a schematic illustration of a client-side processing pipeline executable by the system of FIG. 1, in accordance with non-limiting embodiments of the present technology;

FIG. 4 is a schematic illustration of a server-side processing pipeline executable by the system of FIG. 1, in accordance with non-limiting embodiments of the present technology; and

FIG. 5 is a schematic illustration of a method executable by the system of FIG. 1, in accordance with non-limiting embodiments of the present technology.

FIG. 6is a schematic illustration of an other method executable by the server of FIG. 1, in accordance with non-limiting embodiments of the present technology.

It will be noted that throughout the appended drawings, like features are identified by like reference numerals.

### DETAILED DESCRIPTION

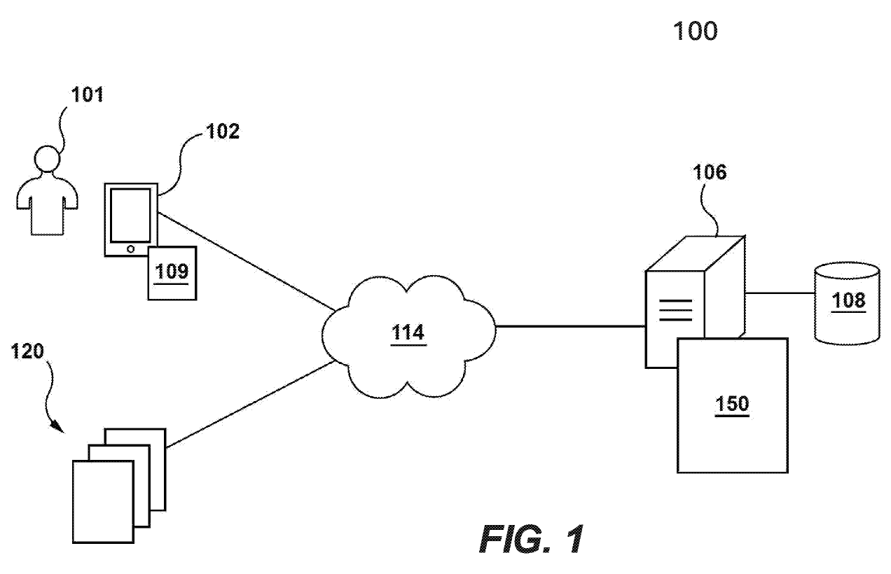

Referring to FIG. 1, there is shown a schematic diagram of a system 100, the system 100 being suitable for implementing non-limiting embodiments of the present technology. It is to be expressly understood that the system 100 is depicted merely as an illustrative implementation of the present technology. Thus, the description thereof that follows is intended to be only a description of illustrative examples of the present technology. This description is not intended to define the scope or set forth the bounds of the present technology. In some cases, what are believed to be helpful examples of modifications to the system 100 may also be set forth below. This is done merely as an aid to understanding, and, again, not to define the scope or set forth the bounds of the present technology. These modifications are not an exhaustive list, and as a person skilled in the art would understand, other modifications are likely possible. Further, where this has not been done (i.e. where no examples of modifications have been set forth), it should not be interpreted that no modifications are possible and/or that what is described is the sole manner of implementing that element of the present technology. As a person skilled in the art would understand, this is likely not the case. In addition, it is to be understood that the system 100 may provide in certain instances simple implementations of the present technology, and that where such is the case they have been presented in this manner as an aid to understanding. As persons skilled in the art would understand, various implementations of the present technology may be of a greater complexity.

The examples and conditional language recited herein are principally intended to aid the reader in understanding the principles of the present technology and not to limit its scope to such specifically recited examples and conditions. It will be appreciated that those skilled in the art may devise various arrangements which, although not explicitly described or shown herein, nonetheless embody the principles of the present technology and are included within its spirit and scope. Furthermore, as an aid to understanding, the following description may describe relatively simplified implementations of the present technology. As persons skilled in the art would understand, various implementations of the present technology may be of greater complexity.

Moreover, all statements herein reciting principles, aspects, and implementations of the present technology, as well as specific examples thereof, are intended to encompass both structural and functional equivalents thereof, whether they are currently known or developed in the future. Thus, for example, it will be appreciated by those skilled in the art that any block diagrams herein represent conceptual views of illustrative circuitry embodying the principles of the present technology. Similarly, it will be appreciated that any flowcharts, flow diagrams, state transition diagrams, pseudo-code, and the like represent various processes which may be substantially represented in computer-readable media and so executed by a computer or processor, whether or not such computer or processor is explicitly shown.

The functions of the various elements shown in the figures, including any functional block labeled as a "processor" may be provided through the use of dedicated hardware as well as hardware capable of executing software in association with appropriate software. When provided by a processor, the functions may be provided by a single dedicated processor, by a single shared processor, or by a plurality of individual processors, some of which may be shared. In some embodiments of the present technology, the processor may be a general purpose processor, such as a central processing unit (CPU) or a processor dedicated to a specific purpose, such as a graphics processing unit (GPU). Moreover, explicit use of the term "processor" or "controller" should not be construed to refer exclusively to hardware capable of executing software, and may implicitly include, without limitation, digital signal processor (DSP) hardware, network processor, application specific integrated circuit (ASIC), field programmable gate array (FPGA), read-only memory (ROM) for storing software, random access memory (RAM), and non-volatile storage. Other hardware, conventional and/or custom, may also be included.

In the context of the present specification, a “server” is a computer program that is running on appropriate hardware and is capable of receiving requests (e.g. from electronic devices) over the network, and carrying out those requests, or causing those requests to be carried out. The hardware may be one physical computer or one physical computer system, but neither is required to be the case with respect to the present technology. In the present context, the use of the expression a “at least one server” is not intended to mean that every task (e.g. received instructions or requests) or any particular task will have been received, carried out, or caused to be carried out, by the same server (i.e. the same software and/or hardware); it is intended to mean that any number of software elements or hardware devices may be involved in receiving/sending, carrying out or causing to be carried out any task or request, or the consequences of any task or request; and all of this software and hardware may be one server or multiple servers, both of which are included within the expression “at least one server”.

In the context of the present specification, unless provided expressly otherwise, the words “first”, “second”, “third”, etc. have been used as adjectives only for the purpose of allowing for distinction between the nouns that they modify from one another, and not for the purpose of describing any particular relationship between those nouns. Thus, for example, it should be understood that, the use of the terms “first server” and “third server” is not intended to imply any particular order, type, chronology, hierarchy or ranking (for example) of/between the server, nor is their use (by itself) intended to imply that any “second server” must necessarily exist in any given situation. Further, as is discussed herein in other contexts, reference to a “first” element and a “second” element does not preclude the two elements from being the same actual real-world element. Thus, for example, in some instances, a “first” server and a “second” server may be the same software and/or hardware, in other cases they may be different software and/or hardware.

In the context of the present specification, unless provided expressly otherwise, a “database” is any structured collection of data, irrespective of its particular structure, the database management software, or the computer hardware on which the data is stored, implemented or otherwise rendered available for use. A database may reside on the same hardware as the process that stores or makes use of the information stored in the database or it may reside on separate hardware, such as a dedicated server or plurality of servers.

With these fundamentals in place, we will now consider some non-limiting examples to illustrate various implementations of aspects of the present technology.

### Client device

The system 100 comprises an client device 102. The client device 102 is associated with a user 101 and, as such, can sometimes be referred to as a “client device” or “user device”. It should be noted that the fact that the client device 102 is associated with the user does not mean to suggest or imply any mode of operation – such as a need to log in, a need to be registered or the like.

In the context of the present specification, unless provided expressly otherwise, “electronic device” is any computer hardware that is capable of running a software appropriate to the relevant task at hand. Thus, some (non-limiting) examples of electronic devices include personal computers (desktops, laptops, netbooks, etc.), smartphones, and tablets, as well as network equipment such as routers, switches, and gateways. It should be noted that a device acting as an electronic device in the present context is not precluded from acting as a server to other electronic devices. The use of the expression “an electronic device” does not preclude multiple client devices being used in receiving/sending, carrying out or causing to be carried out any task or request, or the consequences of any task or request, or steps of any method described herein.

The client device 102 may comprise a permanent storage (not depicted) in a form of one or more storage media and generally provides a place to store computer-executable instructions executable by a processor (not depicted). By way of example, the permanent storage may be implemented as a computer-readable storage medium including Read-Only Memory (ROM), hard disk drives (HDDs), solid-state drives (SSDs), and flash-memory cards.

The client device 102 comprises hardware and/or software and/or firmware (or a combination thereof), as is known in the art to execute a browser application 109. Generally speaking, the purpose of the browser application 109 is to enable the user 101 to access one or more web resources. The manner in which the browser application 109 is implemented is known in the art and will not be described herein. Suffice to say that the browser application 109 may be one of Google^{TM} Chrome^{TM}, Yandex.Browser^{TM}, or other commercial or proprietary browsers.

Irrespective of how the browser application 109 is implemented, the browser application 109, typically, has a command interface (not depicted) and a browsing interface (not depicted). Generally speaking, the user 101 can access a given web resource by entering an address of the web resource (typically an URL or Universal Resource Locator, such as www.example.com) into the command interface, or by clicking a link in an email or in another web resource for being redirected to the given web resource, and in turn, content of the given web resource may be displayed in the browsing interface for the user 101.

Alternatively, the given user 101 may conduct a search using a search engine service (not depicted) to locate a resource of interest based on the user’s search intent. The latter is particularly suitable in those circumstances, where the given user knows a topic of interest, but does not know the URL of the web resource she is interested in. The search engine typically returns a Search Engine Result Page (SERP) containing links to one or more web resources that are responsive to the user query. Again, upon the user clicking one or more links provided within the SERP, the user can open the required web resource.

More specifically, when the user 101 attempts to access a webpage, the browser application 109 is configured to acquire and process different types of data that are indicative of the structure, content, and interactive elements of the webpage. For example, upon initiating an HTTP request, the browser application 109 transmits metadata to a web resource such as the “User-Agent” string, which identifies the browser type, version, and operating system, as well as headers including “Accept”, which specifies preferred content formats, and “Referer”, which indicates the originating URL from which the request was initiated. The browser application 109 may also transmit security-related headers such as “Content-Security-Policy”, which defines content loading restrictions, and other directives that influence resource retrieval and execution.

Once the webpage is received, the browser application 109 is configured to process its content, including HTML, CSS, JavaScript, and multimedia elements. The browser application 109 retrieves and executes JavaScript, enabling the dynamic modification of the Document Object Model (DOM), which represents the structure of the webpage, including text, images, hyperlinks, form elements, and embedded media. JavaScript also facilitates the execution of client-side scripts that can retrieve, modify, and dynamically generate content through asynchronous requests via fetch(), XMLHttpRequest, or WebSockets, for example. Additionally, the browser application 109 interprets cascading style sheets (CSS) to apply visual styles to page elements, affecting layout, positioning, and user interface presentation.

It is contemaplted that the browser application 109 can access locally stored data associated with the webpage, including cookies, LocalStorage, SessionStorage, and IndexedDB. These storage mechanisms contain authentication tokens, session identifiers, user preferences, and cached resources, allowing the webpage to maintain state information across visits. Cookies may be transmitted with HTTP requests to enable user authentication and personalized content delivery, while LocalStorage and SessionStorage provide client-side persistence for structured data, reducing the need for repeated server requests.

User interaction data is also accessible to the browser application 109, allowing it to capture and process events such as mouse movements, keyboard inputs, scroll behavior, and form submissions. This data is utilized for content updates, user experience optimizations, and behavioral analytics. Additionally, the browser application 109 can detect the visibility state of the webpage, determining whether it is in the foreground or background, which influences resource loading and execution prioritization.

Rendering and performance metrics can be collected by the browser application 109 to monitor the efficiency of content presentation. This includes document load times, render times, and resource loading performance, which provide insights into how quickly various page elements become available to the user.

As it will be described in greater details herein further below, the browser application 109 may use a variety of client-side data associated with a given webpage that the user is attempting to access in order to execute one or more machine learning models.

### Communication network

The client device 102 comprises a communication interface (not depicted) for two-way communication with a communication network 114 via a communication link (not numbered). In some non-limiting embodiments of the present technology, the communication network 114 can be implemented as the Internet. In other embodiments of the present technology, the communication network 114 can be implemented differently, such as any wide-area communication network, local area communications network, a private communications network and the like.

How the communication link is implemented is not particularly limited and depends on how the client device 102 is implemented. Merely as an example and not as a limitation, in those embodiments of the present technology where the client device 102 is implemented as a wireless communication device (such as a smart phone), the communication link can be implemented as a wireless communication link (such as, but not limited to, a 3G communications network link, a 4G communications network link, a Wireless Fidelity, or WiFi®, for short, Bluetooth®, or the like) or wired (such as an Ethernet based connection).

It should be expressly understood that implementations for the client device 102, the communication link and the communication network 114 are provided for illustration purposes only. As such, those skilled in the art will easily appreciate other specific implementational details for the client device 102, the communication link and the communication network 114. As such, by no means the examples provided hereinabove are meant to limit the scope of the present technology.

### Web servers

The system 100 further comprises a plurality of web servers 120 coupled to the communication network 114. A given one of the plurality of web servers 120 can be implemented as a conventional computer server. In an example of an embodiment of the present technology, the given web server can be implemented as a Dell^{TM} PowerEdge^{TM} Server running the Microsoft^{TM} Windows Server^{TM} operating system. Needless to say, the given web server can be implemented in any other suitable hardware and/or software and/or firmware or a combination thereof.

In some embodiments of the present technology, and generally speaking, the plurality of web servers 120 function as repositories for web resources. In the context of the present specification, the term “web resource” refers to any network resource (such as a webpage, web site), which its content is presentable visually by the client device 102 to the user, via the browser application 109, and associated with a particular web address (such as a URL).

A given web resource hosted by one or more of the plurality of web servers 120 may be accessible by the client device 102 via the communication network 114, for example, by means of the user typing in the URL in the browser application 109 or executing a web search using the search engine (not depicted). Needless to say, in some cases, a given web server amongst the plurality of web servers 120 may host one or more web resources, while in other cases, a given web resource may be hosted by one or more web servers amongst the plurality of web servers 120.

It is contemplated that a given web resource may be a malicious web resource. In the context of the present technology, a “malicious” webpage or resource is designed to execute unauthorized actions on a user’s device, compromise data security, and/or manipulate browser behavior through deceptive or exploitative techniques.

In some scenarios, a malicious webpage may deploy obfuscated and/or dynamically injected scripts that exploit browser vulnerabilities, manipulate the DOM, and/or execute unauthorized background processes. These scripts may include unauthorized data exfiltration mechanisms, such as keylogging, clipboard monitoring, and/or event interception, allowing the webpage to capture user inputs, authentication credentials, and/or personally identifiable information. In other scenarios, malicious resources may also be embedded within a webpage through remote script execution, inline scripting, and/or third-party dependencies that introduce security threats. These resources may initiate drive-by downloads, where malicious executables are installed without user interaction. In further scenarios, malicious webpages may employ phishing techniques, presenting deceptive user interfaces that mimic legitimate web services to collect authentication credentials or financial information.

### Server

The system 100 further includes a server 106 coupled to the communication network 114. The server 106 can be implemented as a conventional computer server. In an example of an embodiment of the present technology, the server 106 can be implemented as a Dell^{TM} PowerEdge^{TM} Server running the Microsoft^{TM} Windows Server^{TM} operating system. Needless to say, the server 106 can be implemented in any other suitable hardware and/or software and/or firmware or a combination thereof. In the depicted non-limiting embodiment of the present technology, the server 106 is a single server. In alternative non-limiting embodiments of the present technology, the functionality of the server 106 may be distributed and may be implemented via multiple servers.

The implementation of the server 106 is well known. However, briefly speaking, the server 106 comprises a communication interface (not depicted) structured and configured to communicate with various entities (such as the client device 102 and other devices potentially coupled to the communication network 114) via the communication network 114.

Similar to the client device 102, the server 106 comprises one or more storage media and generally provides a place to store computer-executable program instructions executable by one or more processors (not depicted) of the server 106. By way of example, the one or more storage media may be implemented as tangible computer-readable storage medium including Read-Only Memory (ROM) and/or Random-Access Memory (RAM) and may also include one or more fixed storage devices in the form of, by way of example, hard disk drives (HDDs), solid-state drives (SSDs), and flash-memory cards.

In some embodiments, the server 106 can be operated by the same entity that has provided the afore-described browser application 109. For example, if the browser application 109 is a Yandex.Browser^{TM}, the server 106 can be operated by Yandex^{TM} LLC. In alternative embodiments, the server 106 can be operated by an entity different from the one who has provided the aforementioned browser application 109.

In the context of the present technology, the server 106 hosts a verification engine 150 configured to perform one or more operations for triggering a remedial action in response to the client device 102 accessing a malicious webpage via the browser application 109. As it will be described in greater details herein further below, the server 106 may use client-side data and server-side data associated with a given webpage for executing one or more machine learning algorithms in the verification engine 150.

### Database

The system 100 comprises a database system 108 which is a structured framework designed to store, manage, and retrieve data efficiently. The database system 108 may be implemented using a storage system, which can be either physical (on-premises servers) and/or cloud-based depending on inter alia specific implementations of the present technology.

The database system 108 comprises a database, which is an organized collection of data, and a database management system (DBMS), which provides the necessary tools and interfaces for interacting with the database. The database system 108 may securely store data, remain accessible to authorized users, and perform data retrieval and manipulation operations.

The DBMS acts as an intermediary between users and the stored data. The DBMS allows users to define the structure of the database, insert and/or modify records, and execute queries using a specialized language such as Structured Query Language (SQL), for example. The DBMS may also manage other functions such as data integrity, security, and concurrency control, without departing from the scope of the present technology.

The data within the database is typically structured in tables (e.g., for relational databases) and/or in more flexible formats such as key-value pairs, documents, and/or graphs (e.g., for NoSQL databases). These systems are classified based on their architecture, with relational databases following a structured schema, while NoSQL databases offer more flexible, scalable data storage solutions.

The server 106 may be configured collect and analyze various types of webpage data from web resources hosted on the plurality of web servers 120 and store said data in the database system 108. For example, the data stored in the database system 108 may comprise webpage content and/or structure information, such as HTML, JavaScript, CSS, embedded links, iframes, and/or scripts. In another example, the data stored in the database system 108 may comprise URLs, domain age, SSL certificates, and WHOIS data for signs of suspicious activity. In a further example, the data stored in the database system 108 may comprise network and server metadata like IP addresses, hosting provider details, DNS records, and HTTP response headers (e.g., for detecting anomalies such as rapidly changing domains or mismatched SSL certificates). In an additional example, the data stored in the database system 108 may comprise user interaction data indicative of redirect chains, pop-ups, automatic downloads, form submissions, keystroke logging attempts, and/or clipboard access.

### Hybrid detection

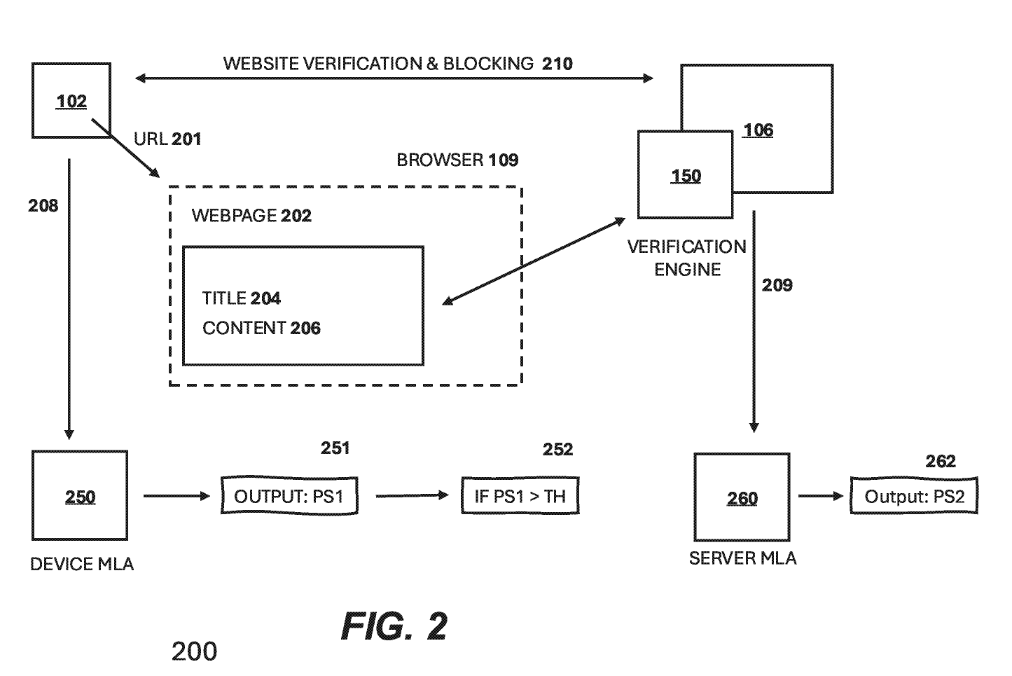

With reference to FIG. 2, there is depicted a schematic representation of a hybrid detection framework 200 executable by the system 100 in FIG. 1. Generally speaking, the hybrid detection framework 200 operates in accordance with a two-stage process comprising (i) a client-side stage using client-side models and data (ii) a server-side stage using server-side model(s) and data. The first stage is executed by the client device 102 using the browser application 109. It should be noted that the first stage may be executed by the client device 102 in real-time and/or before a given webpage is loaded and displayed to a user of the client device 102.

For example, the user 101 may employ the browser application 109 and attempt to access a webpage 202 via a URL 201. The browser application 109 may acquire a title 204 and other content 206 of the webpage 202. The client device 102 may be configured to generate an input 208 using client-side webpage data. For example, the input 208 may comprise information indicative of at least some of the title 204, the URL 201, the other content 206, and one or more content-based counters determined by the client device 102 based on the client-side webpage data.

In one non-limiting example, at least one of the following content-based counters may be employed: a number of links to external domains, a number of images from external domains, an availability of text input and password form, a presence of “brand” reference in the URL.

The client device 102 is configured to provide the input 208 to a plurality of client-side machine learning models 250 for processing. The plurality of client-side machine learning models 250 comprises a first client-side machine learning model and a second client-side machine learning model. The first client-side machine learning model may be a Deep Structured Semantic Model (DSSM). The second client-side machine learning model may be a Gradient Boosting Model (GBM).

The client device is configured to employ the plurality of client-side machine learning models 250 to generate one or more predictions based on the input 208. The one or more predictions may be indicative of a client-side probability score 251 indicative of the likelihood of the webpage being malicious.

In some embodiments, in response to the client-side probability score 251 being above a first pre-determined threshold 252, the client device 102 may be configured to trigger data packet transmission to the server 106. For example, a communication link 210 may be used to transmit data from the client device 102 to the server 106. It is contemplated that the data transmitted to the server 106 for executing the second stage of the hybrid detection framework 200 may comprise one or more embedding(s) generated by the one or more of the plurality of client-side machine learning models 250, one or more prediction(s) generated by the plurality of client-side machine learning models 250, and one or more content-based counters generated based on client-side webpage data.

It should be noted that the second stage of the hybrid detection framework 200 may be executed in response to the client-side probability score 251 being above the first pre-determined threshold 252. In some embodiments, the client device 102 may be configured to transmit client-side data and/or an indication to trigger the second stage of the process. In other embodiments, the server 106 may be configured to trigger the second stage of the process based on data received from the client device 102, without departing from the scope of the present technology.

In some embodiments, the second stage may be executed by the server 106 in real-time and/or before a webpage is loaded and displayed to a user of the client device 102.

The server 106 may employ the verification engine 150 in order to retrieve server-side webpage data about the webpage 202. For example, the verification engine 150 may be configured to acquire server-side webpage data from the database system 108. The server 106 is configured to generate an input 209 based on data received from the client device 102 via the link 210 and server-side webpage data acquired from the database system 108. The input 209 comprises information indicative of one or more embedding(s) acquired from the client device 102, one or more other webpage features acquired from the client device 102, one or more predictions generated by the plurality of client-side machine learning models 250 and acquired from the client device 102, and one or more content-based counter(s) generated based on client-side webpage data and acquired from the client device 102, and one or more additional content-based counters generated by the verification engine 150 and/or acquired from the database system 108.

The client device 102 is configured to provide the input 208 to a server-side machine learning model 260 for processing. The server-side machine learning model 260 may be a GBM. The server-side machine learning model 260 may be configured to generate a server-side probability score 262 indicative of the likelihood of the webpage being malicious.

In response to the server-side probability score 262 being above a server-side pre-defined threshold, the server 106 is configured to trigger an indication for the user via the browser application 109. For example, the server 106 may be configured to transmit data over the link 210 to the client device 102 for triggering a remedial action on the client device. In some embodiments, the client device 102 may be configured to display a visual indicator for the user 101 using the browser application 109. One or more other types of indicators may be triggered for the user 101 via the browser application 109, without departing from the scope of the present technology.

### Client-side stage

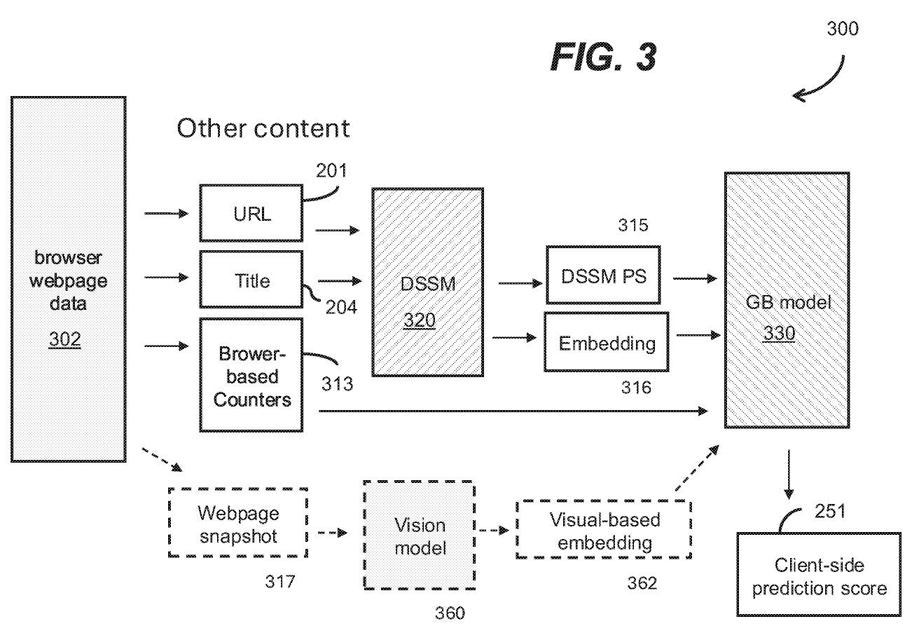

With reference to FIG. 3, there is depicted a schematic representation of a client-side stage 300 of the hybrid detection framework 200 executed by the system 100, in at least some embodiments of the present technology.

During the client-side stage 300, the browser application 109 is configured to acquire browser webpage data 302 in response to the user 101 attempting to access a given webpage 202 using the URL 201. The browser application 109 is configured to extract information indicative of the URL 201, of the title 204, and to generate one or more counters 313 based on the browser webpage data 302.

In this embodiment, the client device 102 is configured to provide the information indicative of the URL 201 and of the title 204 to a DSSM 320 for processing. It is contemplated that other client-side information about the webpage 202 may be provided to the DSSM 320 for processing, without departing from the scope of the present technology.

Broadly, the DSSM 320 is configured to process client-side webpage data to assess a “preliminary” likelihood of whether or not a webpage is malicious. The DSSM 320 utilizes deep learning techniques to extract and analyze meaningful patterns from webpage features, generating a probability score that serves as a “preliminary” indicator of potential malicious threats.

The DSSM 320 may be configured to processes different types of client-side webpage data such as the URL 201 and the title 204 of the webpage 202. The DSSM 320 converts raw data into high-dimensional feature representations using techniques such as embedding layers, Convolutional Neural Networks (CNNs), Recurrent Neural Networks (RNNs), and/or transformers. These representations capture semantic relationships between webpage content, allowing the model to detect patterns that may indicate malicious intent. In this embodiment, the DSSM 320 is configured to generate an embedding 316 based on content-based information about the webpage 202.

To generate a preliminary probability score 315, the DSSM 320 applies learned weights to extracted features and evaluates them using a classification or ranking function. In some embodiments, the DSSM 320 may be configured to generate the preliminary probability score 315 using the embedding 316. As such, at least one of the outputs of the DSSM 320 is indicative of a preliminary probability that a webpage exhibits characteristics associated with malicious activity. For example, higher scores indicate a greater likelihood of the webpage being malicious.

The DSSM 320 can be trained on large datasets of known safe and malicious webpages, leveraging supervised, semi-supervised, or self-supervised learning approaches. Continuous learning from new threats may aid in enhancing the classification accuracy over time. In one non-limiting example, the DSSM 320 may be trained on new threats every week. The training/re-training of the DSSM 320 may be executed on the server and the updated version of model may then be transmitted to one or more client devices.

In this embodiment, the architecture of the DSSM 320 may be configured to aggregate per-title and per-URL representations, in order to assess their similarity using cosine similarity metrics. Developers have realized that malicious webpages often follow naming patterns that resemble legitimate sites, enabling the DSSM 320 to detect such trends effectively.

In this embodiment, the client device 102 is configured to provide the one or more counters 313, the embedding 316, and the preliminary probability score 315 to a client-side GBM 330. Other information may also be provided to the client-side GBM 330 for processing, without departing from the scope of the present technology. Broadly, GBMs are a class of machine learning algorithms that build predictive models using an ensemble of decision trees, where each tree corrects the errors of the previous ones. GBMs employ a boosting technique, where models are trained sequentially, with each new tree learning to reduce the residual errors of the previous trees. This iterative process helps improve predictive accuracy while minimizing overfitting.

GBMs work by optimizing a specified loss function (e.g., mean squared error for regression or log loss for classification) using gradient descent. Each tree contributes a small correction to the final prediction, making GBMs effective for structured data and tabular datasets. Popular implementations of GBMs include XGBoost, LightGBM, and CatBoost, each offering different optimizations for handling categorical features, missing values, and large datasets.

The GBM 330 is configured to generate the client-side probability score 251 indicative of the likelihood of the webpage 202 being malicious. If the client-side probability score 251 is above the client-side pre-determined threshold 252, the client device 102 is configured to transmit data to the server 106 for executing the server-side phase of the hybrid detection framework 200.

In some embodiments of the present technology, the hybrid detection framework 200 may further make use of visual-based features representative of the webpage 202 for determining whether the webpage 202 is malicious or not.

In some embodiments, the browser application 109 may be configured to capture a screenshot 317 of the webpage 202 and provide it to a vision model 360 for processing. The screenshot 317 serves as a visual representation of the webpage’s content, layout, and structure. Once captured, the client device 102 transmits the screenshot 317 to the vision model 360, which processes the image to extract visual features. Broadly, the vision model 360 is a deep learning-based neural network designed for image analysis. CNNs or Transformer-based vision models can be used. These models process an input image by extracting hierarchical features, identifying text patterns, colors, shapes, icons, and layout structures that differentiate webpages. The extracted features are then transformed into an embedding that can be compared against known patterns to detect anomalies, classify content, or support further decision-making processes.

In some embodiments, the vision model 360 may generate a visual-based embedding 362, which is a compact numerical representation that captures characteristics of the webpage’s appearance. The visual-based embedding 362 may also be inputted to the client-side GBM 330 for prediction purposes.

### Server-side stage

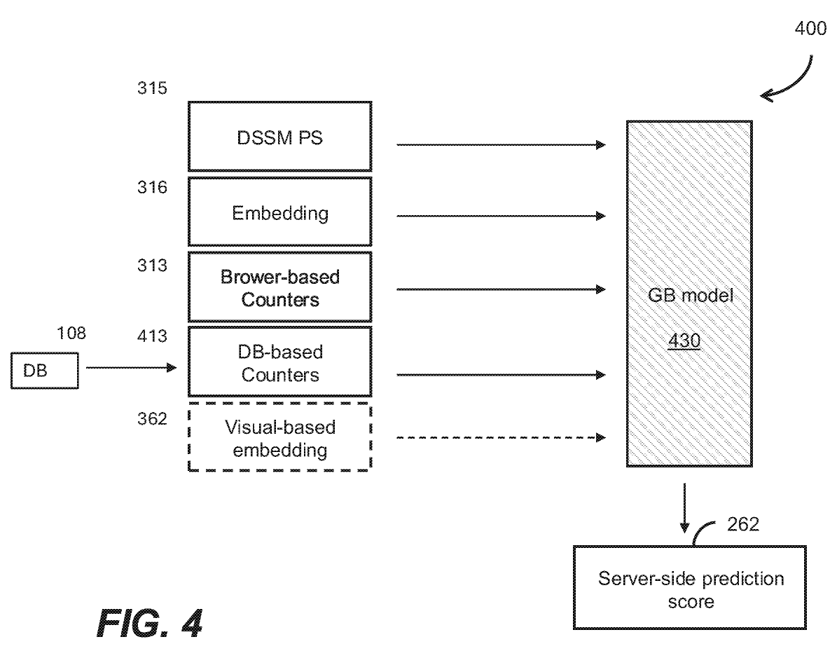

With reference to FIG. 4, there is depicted a schematic representation of a server-side phase 400. The server 106 is configured to acquire the preliminary probability score 315 generate by the DSSM 320, the embedding 316, and the one or more client-side counters 313. Optionally, the server 106 may also be configured to acquire the visual-based embedding 362 generated by the vision model 360. The server 106 is also configured to acquire one or more server-side counters 413 from the database system 108 and associated with the webpage 202.

In this embodiment, the server 106 is configured to provide the one or more counters 313, the one or more counters 413, the embedding 316, and the preliminary probability score 315, and optionally the visual-basedd embedding 362 to a server-side GBM 430. Other information may also be provided to the server-side GBM 430 for processing, without departing from the scope of the present technology.

The server-side GBM 430 is configured to generate the server-side probability score 262 indicative of the likelihood of the webpage 202 being malicious. If the server-side probability score 262 is above the server-side pre-determined threshold, the server 106 is configured to transmit data to the server 106 for triggering a remedial action of the client device 102. For example, a visual element may be triggered in the browser application 109 indicating to the user 101 that the webpage 202 is malicious.

### Computer-implemented method

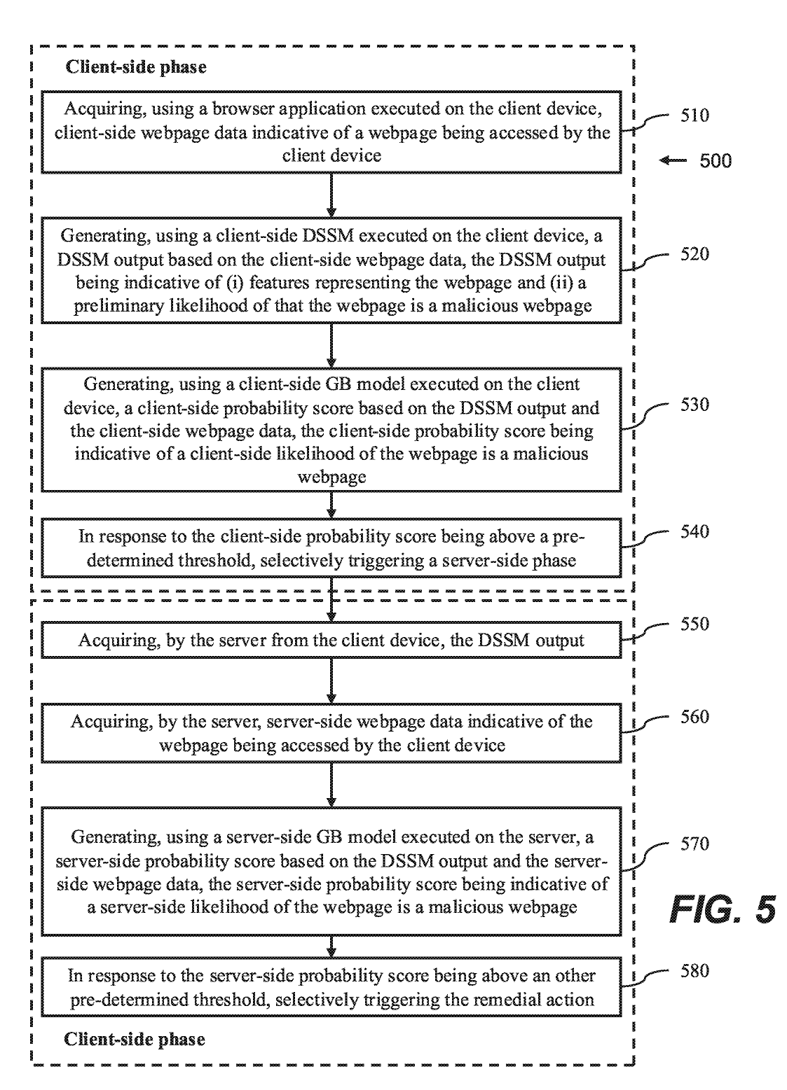

In some embodiments of the present technology, a processor may be configured to execute a computer-implemented method 500, a scheme-block representation of which is illustrated in FIG. 5. Various steps of the method 500 will now be described.

STEP 510: during a client-side phase, acquiring, using a browser application executed on the client device, client-side webpage data indicative of a webpage being accessed by the client device

At step 510, a processor of a client device is configured to acquire, using a browser application, client-side webpage data indicative of a webpage being accessed by the client device.

STEP 520: during a client-side phase, generating, using a client-side DSSM executed on the client device, a DSSM output based on the client-side webpage data

At step 520, a processor of a client device is configured to generate, using a client-side DSSM executed on the client device, a DSSM output based on the client-side webpage data. For example, a processor of the client device 102 may be configured to generate, using a client-side DSSM 320 executed on the client device 102, a DSSM output based on the client-side webpage data.

STEP 530: during a client-side phase, generating, using a client-side GB model executed on the client device, a client-side probability score based on the DSSM output and the client-side webpage data

At step 530, a processor of a client device is configured to generate, using a client-side GB model, a client-side probability score based on the DSSM output and the client-side webpage data. For example, a processor of the client device 102 may be configured to generate, using the client-side GB model 330, a client-side probability score 251 based on the DSSM output and the client-side webpage data.

STEP 540: during a client-side phase, in response to the client-side probability score being above a pre-determined threshold, selectively triggering a server-side phase

At step 540, a processor of a client device is configured to trigger and/or transmit data to a processor of a server for executing the server-side phase, in response to the client-side probability score being above a pre-determined threshold. For example, a processor of the client device 102 may be configured to trigger and/or transmit data to a processor of the server 106 for executing the server-side phase, in response to the client-side probability score 251 being above a pre-determined threshold.

STEP 550: during the server-side phase, acquiring, by the server from the client device, the DSSM output

At step 550, a processor of a server is configured to acquire the DSSM output. For example, a processor of the server 106 may be configured to acquire the DSSM output from the client device 102.

STEP 560: during a client-side phase, acquiring, by the server, server-side webpage data indicative of the webpage being accessed by the client device

At step 560, a processor of a server is configured to acquire server-side webpage data indicative of the webpage being accessed by the client device. For example, a processor of the server 106 may be configured to acquire server-side webpage data indicative of the webpage being accessed by the client device 102.

STEP 570: during a client-side phase, generating, using a server-side GB model executed on the server, a server-side probability score based on the DSSM output and the server-side webpage data

At step 570, a processor of a server is configured to generate, using a server-side GB model, a server-side probability score based on the DSSM output and the server-side webpage data. For example, a processor of the server 106 may be configured to generate, using the server-side GB model 430, a server-side probability score 262 based on the DSSM output and the server-side webpage data.

STEP 580: during a client-side phase, in response to the server-side probability score being above an other pre-determined threshold, selectively triggering the remedial action

At step 580, a processor of a server is configured to, in response to the server-side probability score being above an other pre-determined threshold, selectively trigger a remedial action. For example, a processor of the server 106 may be configured to, in response to the server-side probability score 262 being above an other pre-determined threshold, selectively trigger a remedial action on the client device 102.

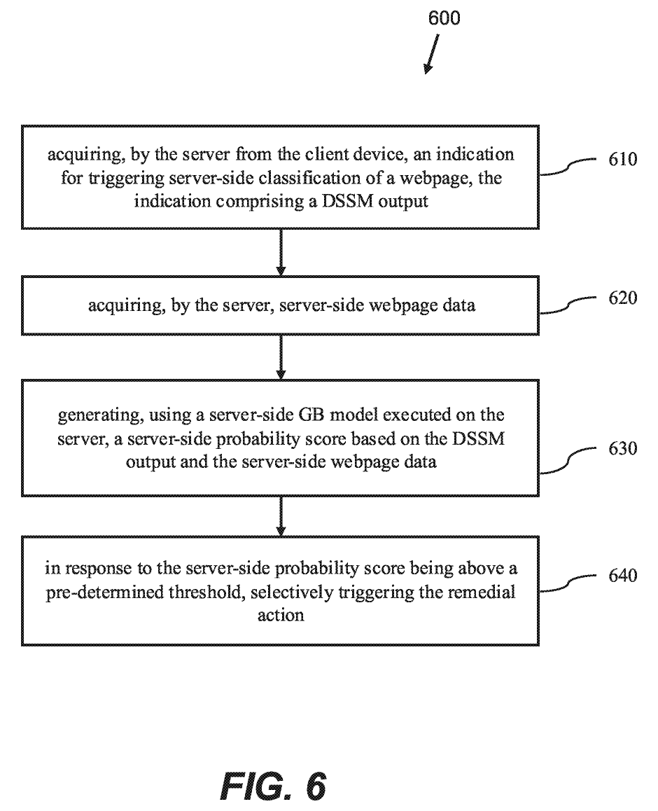

In some embodiments of the present technology, a processor may be configured to execute a computer-implemented method 600, a scheme-block representation of which is illustrated in FIG. 6. Various steps of the method 600 will now be described.

STEP 610: acquiring, by the server from the client device, an indication for triggering server-side classification of a webpage, the indication comprising a DSSM output

At step 610, a processor of a server is configured to acquire from a client device an indication for triggering server-side classification of a webpage. The indication comprises a DSSM output. It is contemplated that the indication is acquired in response to a client-side classification of the webpage, the client-side classification being performed by a DSSM model and a GB model executed on the client device. The DSSM model may have been configured to generate the DSSM output based on browser webpage data. The DSSM output being indicative of (i) features representing the webpage and (ii) a preliminary likelihood of the webpage being a malicious webpage. The GB model may have been configured to generate, based on the DSSM output and the browser webpage data, a client-side probability score indicative of a client-side likelihood of the webpage being a malicious webpage.

STEP 620: acquiring, by the server, server-side webpage data

At step 620, a processor of a server is configured to acquire server-side webpage data. For example, a processor of the server 106 may be configured to acquire server-side webpage data indicative of the webpage being accessed by the client device 102. The server-side webpage data may be acquired from a database system accessible by the server 106.

STEP 630: generating, using a server-side GB model executed on the server, a server-side probability score based on the DSSM output and the server-side webpage data

At step 630, a processor of a server is configured to generate, using a server-side GB model, a server-side probability score based on the DSSM output and the server-side webpage data. The server-side probability score is indicative of a server-side likelihood of the webpage being a malicious webpage. For example, a processor of the server 106 may be configured to generate, using the server-side GB model 430, a server-side probability score 262 based on the DSSM output and the server-side webpage data.

STEP 640: in response to the server-side probability score being above a pre-determined threshold, selectively triggering the remedial action

At step 640, a processor of a server is configured to, in response to the server-side probability score being above a pre-determined threshold, selectively trigger a remedial action. For example, a processor of the server 106 may be configured to, in response to the server-side probability score 262 being above a pre-determined threshold, selectively trigger a remedial action on the client device 102.

Modifications and improvements to the above-described implementations of the present technology may become apparent to those skilled in the art. The foregoing description is indented to be exemplary rather than limiting. The scope of the present technology is therefore intended to be limited solely by the scope of the appended claims.

While the above-described implementations have been described and shown with reference to particular steps performed in a particular order, it will be understood that these steps may be combined, sub-divided, or re-ordered without departing from the teachings of the present technology. Accordingly, the order and grouping of the steps is not a limitation of the present technology.

1. A method of triggering a remedial action on a client device, the client device being communicatively coupled to a server, the method comprising:
during a client-side phase:
acquiring, using a browser application executed on the client device, client-side webpage data indicative of a webpage being accessed by the client device;
generating, using a client-side DSSM executed on the client device, a DSSM output based on the client-side webpage data,
the DSSM output being indicative of (i) features representing the webpage and (ii) a preliminary likelihood of that the webpage is a malicious webpage;
generating, using a client-side GB model executed on the client device, a client-side probability score based on the DSSM output and the client-side webpage data,
the client-side probability score being indicative of a client-side likelihood of the webpage is a malicious webpage; and
in response to the client-side probability score being above a pre-determined threshold, selectively triggering a server-side phase; and
during a server-side phase:
acquiring, by the server from the client device, the DSSM output;
acquiring, by the server, server-side webpage data indicative of the webpage being accessed by the client device;
generating, using a server-side GB model executed on the server, a server-side probability score based on the DSSM output and the server-side webpage data,
the server-side probability score being indicative of a server-side likelihood of the webpage is a malicious webpage; and
in response to the server-side probability score being above an other pre-determined threshold, selectively triggering the remedial action.

2. The method of claim 1, wherein the method further comprises generating one or more client-side counters based on the client-side webpage data.

3. The method of claim 1, wherein the client-side webpage data comprises a URL, a title, and other content of webpage.

4. The method of claim 1, wherein the method further comprises generating one or more server-side counters based on the server-side webpage data.

5. The method of claim 1, wherein the method further comprises the DSSM output comprises one or more embeddings indicative of features representing the webpage, and a preliminary probability score.

6. The method of claim 1, wherein the method further comprises using a vision model to generate an other embedding indicative of visual features of a screenshot of the webpage generated by the browser application, and using the other embedding for generating the client-side probability score.

7. The method of claim 1, wherein the selectively triggering the remedial action comprises triggering display of a visual element to a user using the browser application and indicative of that the webpage is a malicious webpage.

8. A system for triggering a remedial action on a client device, the system comprising the client device communicatively coupled to a server, the system being configured to:
during a client-side phase:
acquire, using a browser application executed on the client device, client-side webpage data indicative of a webpage being accessed by the client device;
generate, using a client-side DSSM executed on the client device, a DSSM output based on the client-side webpage data,
the DSSM output being indicative of (i) features representing the webpage and (ii) a preliminary likelihood of that the webpage is a malicious webpage;
generate, using a client-side GB model executed on the client device, a client-side probability score based on the DSSM output and the client-side webpage data,
the client-side probability score being indicative of a client-side likelihood of the webpage is a malicious webpage; and
in response to the client-side probability score being above a pre-determined threshold, selectively trigger a server-side phase; and
during the server-side phase:
acquire, by the server from the client device, the DSSM output;
acquire, by the server, server-side webpage data indicative of the webpage being accessed by the client device;
generate, using a server-side GB model executed on the server, a server-side probability score based on the DSSM output and the server-side webpage data,
the server-side probability score being indicative of a server-side likelihood of the webpage is a malicious webpage; and
in response to the server-side probability score being above an other pre-determined threshold, selectively trigger the remedial action.

9. The system of claim 8, wherein the system is further configured to generate one or more client-side counters based on the client-side webpage data.

10. The system of claim 8, wherein the client-side webpage data comprises a URL, a title, and other content of webpage.

11. The system of claim 8, wherein the system is further configured to generate one or more server-side counters based on the server-side webpage data.

12. The system of claim 8, wherein the DSSM output comprises one or more embeddings indicative of features representing the webpage, and a preliminary probability score.

13. The system of claim 8, wherein the system is further configured to use a vision model to generate an other embedding indicative of visual features of a screenshot of the webpage generated by the browser application, and to use the other embedding for generating the client-side probability score.

14. The system of claim 8, wherein to selectively trigger the remedial action comprises the system configured to trigger display of a visual element to a user using the browser application and indicative of that the webpage is a malicious webpage.

15. A method of triggering a remedial action on a client device, the client device being communicatively coupled to a server, the method comprising:
acquiring, by the server from the client device, an indication for triggering server-side classification of a webpage, the indication comprising a DSSM output,
the indication being acquired in response to a client-side classification of the webpage, the client-side classification being performed by a DSSM model and a GB model executed on the client device,
the DSSM model having been configured to generate the DSSM output based on browser webpage data, the DSSM output being indicative of (i) features representing the webpage and (ii) a preliminary likelihood of the webpage being a malicious webpage, and
the GB model having been configured to generate, based on the DSSM output and the browser webpage data, a client-side probability score indicative of a client-side likelihood of the webpage being a malicious webpage,
acquiring, by the server, server-side webpage data;
generating, using a server-side GB model executed on the server, a server-side probability score based on the DSSM output and the server-side webpage data,
the server-side probability score being indicative of a server-side likelihood of the webpage being a malicious webpage; and
in response to the server-side probability score being above a pre-determined threshold, selectively triggering the remedial action.
